(19) United States
(12) Patent Application Publication
(10) Pub. No.: US 2025/0331044 A1
(43) Pub. Date: Oct. 23, 2025

(54) METHOD FOR TRANSFERRING DATA AND ASSOCIATED DEVICE

(71) Applicant: Aktiebolaget SKF, Göteborg (SE)

(72) Inventors: Fredrik SUNDQUIST, Luleå (SE); Per-Erik LARSSON, Luleå (SE); Stig Fredrik OLOFSSON, Råneå (SE)

(21) Appl. No.: 19/174,226

(22) Filed: Apr. 9, 2025

(30) Foreign Application Priority Data
Apr. 17, 2024 (DE) 102024203542.4

(51) Int. Cl. H04W 76/15; H04W 12/03; H04W 24/10

(52) U.S. Cl. CPC H04W 76/15; H04W 12/03; H04W 24/10

(57) ABSTRACT

A mobile device (3) for transferring data between a condition monitoring device (40) having at least one sensor (2) and at least one processing device (4). The device also includes a first communication means (11), a second communication means (12), and a memory (13). The first communication means (11) communicates with the sensor (2) to arrange a first transmission path between the condition monitoring device and the mobile device (3) to transfer data between the condition monitoring device and the mobile device. The second communication means (12) communicates with the processing device (4) to arrange a second transmission path between the processing device (4) and the mobile device (3) to transfer data between the processing device and the mobile device. The memory (13) stores data transfer through the first and second transmission path.

### CROSS-REFERENCE TO RELATED APPLICATION

This application claims priority to German Application No. 102024203542.4, filed Apr. 17, 2024, the entirety of which is hereby incorporated by reference.

### FIELD

The present invention is directed to data transfer, for example in a condition monitoring device.

More particularly, the invention deals with a method for transferring data between a condition monitoring device comprising at least one sensor and at least one processing device and a mobile device for transferring data between at least one sensor and at least one processing device.

### BACKGROUND

A machine generally comprises sensors connected to at least one condition monitoring device for monitoring parts of the machine, for example rolling bearings.

Each sensor may deliver data comprising measurements to a backend system comprising a processing device for further processing through a network, for example a wireless network.

The backend system may for example detect a fault of a bearing from measurements sent by the sensor.

However, when the machine is in an area where the network is not available, the measurements cannot be sent to the backend end system.

It is known to implement a portable data collector to collect the measurements and to transfer collected data to the backend system when a network is available.

However, the portable data collector is very costly and may not collect measurements at good running conditions.

Further, implementing the portable data collector needs to redefine the interfaces of the sensor and the backend system.

Consequently, the present invention intends to transfer data delivered by a sensor to a backend system in an easiest way when the sensor and the backend system are not linked by a network.

### SUMMARY

According to an aspect, a method for transferring data between a condition monitoring device comprising at least one sensor and at least one processing device, the method comprising:
an arrangement of a first transmission path between a mobile device and the condition monitoring device,
a first data transfer comprising transferring first data from the condition monitoring device to a mobile device through the first transmission path, the first data being generated by the sensor,
storing the first data in a memory of the mobile device,
an arrangement of a second transmission path between the mobile device and the processing device, and
a second data transfer comprising transferring second data from the mobile device to the processing device through the second transmission path, the second data being determined by processing means of the mobile device from the first data.

The use of the mobile device allows to transfer data between the sensor and the processing device in an easiest way when the sensor and the backend system are not linked by a network.

The mobile device may be a laptop or a smartphone.

Preferably, third data are stored in the memory of the mobile device, the first data transfer further comprise transferring the third data from the memory of the mobile device to the condition monitoring device through the first transmission path.

Advantageously, the second data transfer further comprise transferring fourth data from the processing device to the mobile device through the second transmission path, the method further comprising storing the fourth data in the memory of the mobile device.

Preferably, the method comprises the display of the content of the memory of the mobile device on a screen of the mobile device.

Advantageously, the method comprises a delivery of an information signal to a human machine interface of the mobile device, the information signal being representative of the data transfer progress of at least one data transfer of the first and second data transfers.

Preferably, the first data comprise measurement data generated by the sensor and second data comprise resulting data.

Preferably, the method comprises:
an encryption of resulting data generated by the processing means of the mobile device from measurement data delivered by the sensor, the resulting data being encrypted by processing device encrypting means of the mobile device before the second data transfer, the second data comprising the encrypted resulting data by processing device encrypting means, and
a decryption of the second data by decrypting means of the processing device to obtain the resulting data, the second data being received by the processing device during the second data transfer.

Advantageously, the method comprises an encryption of measurement data by encrypting means of the sensor before the first data transfer, the measurement data being generated by the sensor, the first data comprising the encrypted measurement data.

Preferably, the method comprises a decryption of the first data by sensor decrypting means of the mobile device to obtain the measurement data, the first data being received by the mobile device during the first data transfer.

Advantageously, the method comprises:
a data processing of resulting data by the processing device,
a generation of reporting data, the second data transfer further comprising transferring the reporting data from the processing device to the mobile device and storing the reporting data in the memory of the mobile device.

According to another aspect, a mobile device for transferring data between at condition monitoring device comprising least one sensor and at least one processing device is proposed.

The device comprises:
first communication means configured to communicate with the condition monitoring device to arrange a first transmission path between the sensor and the mobile device, transfer data between the condition monitoring device and the mobile device,
second communication means configured to communicate with the processing device to arrange a second transmission path between the processing device and the mobile device, transfer data between the processing device and the mobile device, and
a memory configured to store data transfer through the first and second transmission path.

### BRIEF DESCRIPTION OF THE DRAWINGS

Other advantages and features of the invention will appear on examination of the detailed description of embodiments, in no way restrictive, and the appended drawings in which:

FIG. 1 illustrates schematically an example of a data transfer system according to the invention; and

FIG. 2 illustrates schematically an example of a method for transferring data according to the invention.

### DETAILED DESCRIPTION

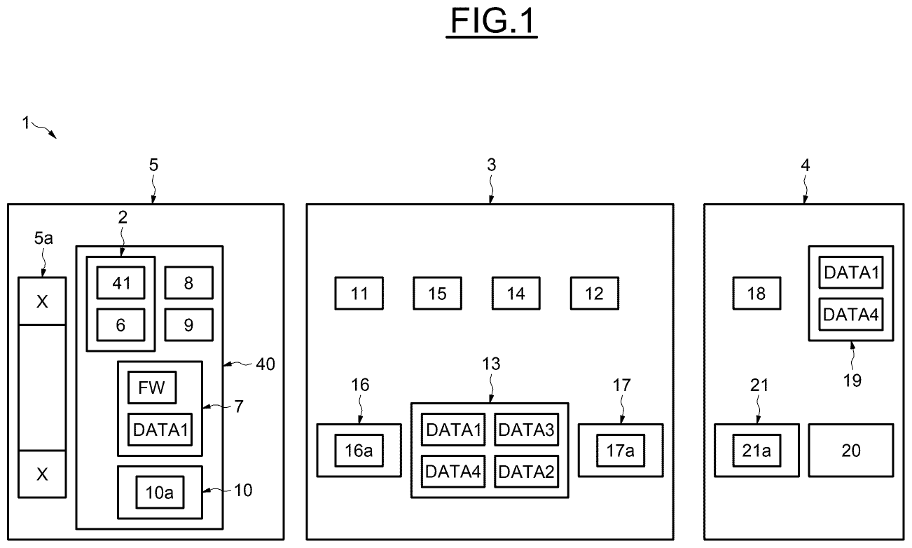

Reference is made to FIG. 1 which represents schematically an example of a data transfer system 1.

The data transfer system 1 comprises at least one condition monitoring device 40 comprising at least one sensor 2, a mobile device 3 and a processing device 4.

The mobile device 3 may be a smartphone or a laptop.

The condition monitoring device 40 may be implemented in a machine 5 for example for monitoring a bearing 5a of the machine 5.

The machine 5 may be located on a boat.

The sensor 2 may deliver vibration measurements of the bearing 5a.

The sensor 2 comprises sensing means 6 intended to measure at least one physical parameter of the bearing 5a and communication means 41.

The condition monitoring device 40 further comprises a memory 7, communication means 8, and a processing unit 9 intended to implement the sensing means 6, the memory and the communication means 8 intended to communicate with the communication means 41 of the sensor 2.

The condition monitoring device 40 may further comprise a cypher module 10 implemented by the processing unit 9.

The physical parameter may be the temperature of the bearing and/or the speed of the bearing and/or vibrations of the bearing.

The memory 7 stores a firmware FW of the condition monitoring device 40.

The mobile device 3 comprises first communication means 11 intended to communicate with the communication means 8 of the sensor 2, second communication means 12, a memory 13, a screen 14 and processing means comprising for example a processing unit 15.

The mobile device 3 may further a first cypher module 16 and a second cypher module 17.

The processing unit 15 is intended to implement the first communication means 11, the second communication means 12, the memory 13, the screen 14, the first cypher module 16 and the second cypher module 17.

The processing device 4 comprises communication means 18 intended to communicate with the second communication means 12 of the mobile device 3, a memory 19 and a processing unit 20.

The processing unit 20 is intended to implement the communication means 18 and the memory 19.

The processing device 4 may further comprise a cypher module 21 implemented by the processing unit 20 of the processing device 4.

The communication means 8 of the condition monitoring device 40 and the first communication means 11 of the mobile device 3 implement for example a first wireless communication protocol.

The second communication means 12 of the mobile device 3 and the communication means 18 of the processing device 4 implement for example a second wireless communication protocol.

The communication means 8 of the condition monitoring device 40 and the communication means 41 of the sensor 2 implement for example a third wireless communication protocol.

The first wireless communication protocol and the second wireless communication protocol may be identical so that the mobile device 3 comprises communication means replacing the first and second communication means 11, 12, the communication means being intended to communicate with the communication means of the condition monitoring device 40 and the communication means of the processing device 4.

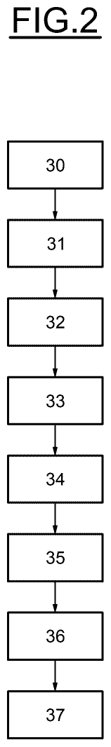

FIG. 2 illustrates schematically an example of a method for transferring data between the condition monitoring device 40 and the processing device 4.

It is assumed that the machine 5 is in an area where the network is not available so that the communication means 8 of the condition monitoring device 40 and the first communication means 11 of the mobile device 3 are not available to exchange data.

It is assumed that first data DATA1 are stored in the memory 7 of the condition monitoring device 40, third data DATA3 are stored in the memory 13 of the mobile device 3 and fourth data DATA4 are stored in the memory 19 of the processing device 4 (FIG. 1).

The first data DATA1 may comprise data measurement delivered by the sensing means 6 and transferred to the condition monitoring device 40 through the communication means 41 of the sensor 2. The first data DATA1 may be encrypted by encrypting means 10a of the cypher module 10 of the condition monitoring device 40.

The third data DATA3 may comprise a first update of the firmware FW or configuration data for example to update the sensor 2.

During a step 30, when the communication means 8 of the condition monitoring device 40 and the first communication means 11 of the mobile device 3 are able to communicate, the first communication means 11 of the mobile device 3 and the communication means 8 of the condition monitoring device 40 arrange a first transmission path between the sensor 2 and the mobile device 5.

During a step 31, when the first transmission path is established, a first data transfer is initiated between the condition monitoring device 40 and the mobile device 5.

The first data transfer comprises transferring the first data DATA1 from the condition monitoring device 40 to the mobile device 3 through the first transmission path.

The first data DATA1 are received by the first communication means 11 of the mobile device 3 and stored in the memory 13 of the mobile device 3.

The first data transfer DATA1 further comprise transferring the third data DATA3 from the memory 13 of the mobile device 3 to the condition monitoring device 40 through the first transmission path.

The third data DATA3 are stored in the memory 7 of condition monitoring device 40 and may be implemented by the processing unit 6 of the condition monitoring device 40 to update the firmware FW.

During a step 32, the first transmission path may be closed.

The processing unit 15 of the mobile device 3 determines second data DATA2 from the first data DATA1.

The second data DATA2 may comprise resulting data.

Sensor decrypting means 16a of the cypher module 16 of the mobile device 3 may decrypt the first data DATA1 to obtain the measurement data.

The measurement data may be processed by the processing unit 15 of the mobile device 3 for example to display the measurement data on the screen 14.

The measurement data may be processed by the processing unit 15 of the mobile device 3 so that the content of the measurement data form computed data.

The resulting data may comprise the measurement data or the computed data.

If the measurement data are not displayed on the screen 14 or process by the processing unit 15, the first data DATA1 may be not decrypted by the sensor decrypting means 16a and the resulting data comprise the first data DATA1, the second data DATA2 being identical to the first data DATA1.

In variant, the first data DATA1 are not encrypted.

During a step 33, when the communication means 18 of the processing device 4 and the second communication means 21 of the mobile device 3 are able to communicate, the second communication means 12 of the mobile device 3 and the communication means 18 of the processing device 4 arrange a second transmission path between the mobile device 3 and the processing device 4.

During a step 34, when the second transmission path is established, a second data transfer is initiated between the condition monitoring device 40 and the mobile device 5.

During a step 35, when the second transmission path is established, a second data transfer is initiated between the mobile device 3 and the processing device 4.

The second data transfer comprises transferring the second data DATA2 from the mobile device 3 to the processing device 4 through the second transmission path.

The second data DATA2 are received by the communication means 18 of the processing device 4 and stored in the memory 19 of the processing device 4.

The second data transfer further comprises transferring fourth data DATA4 from the processing device 4 to the mobile device 3 through the second transmission path.

The fourth data DATA4 are stored in the memory 13 of the mobile device 3.

The fourth data DATA4 comprise for example a firmware update or configuration data.

The second data transfer may further comprise transferring reporting data which are determined by the processing device 4 from the second data DATA2 exchange previously between the mobile device 3 and the processing device 4. The generation of reporting data is explained in the following.

The reporting data are stored in the memory 13 of the mobile device 3.

During a step 36, the second transmission path may be closed.

In variant, the first and second transmission paths may be opened simultaneously so that the first data transfer and the second data transfer are done simultaneously, and closed when both data transfers are finished.

The decrypting means 21a of the cypher module 16 of the mobile device 3 may decrypt the second data DATA2 to obtain the resulting data.

In variant the second data DATA2 are not encrypted.

The resulting data may be processed by the processing unit 20 of the processing device 4 for example to generate reporting data.

The reporting data may comprise the state of the bearing 5 such as the rating life of the bearing 5, detection of a spall in the bearing 5.

The bearing 5 may further comprise an alarm to warn for example for the replacement of the bearing 5.

The content of the memory 13 of the mobile device 3 may be displayed on the screen 14 of the mobile device 3.

During the first data transfer at step 31 and the second data transfer at step 34, the processing unit 15 of the mobile device 3 may deliver an information signal to a human machine interface of the mobile device 3.

The information signal is representative of the data transfer progress of at least one data transfer of the first and second data transfers.

The human machine interface may be the screen 14 of the mobile device 3 so that the data transfer progress may be represented by a bar.

Of course, the data exchanges from the processing device 4 to the mobile device 3 and from the mobile device 3 to the condition monitoring device 40 may encrypted and decrypted by the cypher module 21 of the processing device 4, the first and second cypher modules 16, 17 of the mobile device 3, and the cypher module 10 of the condition monitoring device 40.

The condition monitoring device 40 may comprise a plurality of sensors 2. so that during the first data transfer, data generated by each sensor of the plurality of sensors are exchanged between the condition monitoring device 40 and the mobile device 3.

The mobile device 3 may be connected simultaneously to a plurality of processing devices so that during the second data transfer, data are exchanged between each processing device of the plurality of processing devices and the mobile device 3.

The data exchanged during the first and second data transfers may comprise a plurality of data packets.

Each data packet of the first data DATA1 may have an identification number so that two successive data packets have two successive numbers.

If the first data transfer is interrupted before that the first data DATA1 is transferred from the condition monitoring device 40 to the mobile device 3, when the first data transfer is reestablished, only the data packets having an identification number which is not stored in the memory 13 of the mobile device 3 are transferred to minimize the data flow exchanged between the condition monitoring device 40 and the mobile device 3.

Of course, the second, third and fourth DATA2, DATA3, DATA4 may comprise data packets having successive numbers.

The use of the mobile device 3 to transfer data between the condition monitoring device 40 and the processing device 4 allows that the condition monitoring device 40 and the processing device 4 communicate without modifying communication protocols implemented in the sensor and processing device on contrary to the use of a portable data collector known from the prior art.

The communication means of the condition monitoring device 40 and the processing device 4 are not modified on contrary to the use of a portable data collector known from the prior art whose implementation needs to modify the communication means of the sensor 2 and the processing device 4.

Consequently, the use of the mobile device 3 allows to transfer data between the sensor 2 and the processing device 4 in an easiest way when the sensor and the backend system are not linked by a network.

What is claimed is:

1. A method for transferring data between a condition monitoring device comprising at least one sensor and at least one processing device, the method comprising:
forming a first transmission path between a mobile device and the condition monitoring device;
a first data transfer comprising transferring first data from the condition monitoring device to a mobile device through the first transmission path, the first data being generated by the sensor;
storing the first data in a memory of the mobile device;
forming a second transmission path between the mobile device and the processing device; and
a second data transfer comprising transferring second data from the mobile device to the processing device through the second transmission path, the second data being determined by processing means of the mobile device from the first data.

2. The method according to claim 1, wherein third data is stored in the memory of the mobile device, the first data transfer further comprises transferring the third data from the memory of the mobile device to the condition monitoring device through the first transmission path.

3. The method according to claim 2, wherein the second data transfer further comprises transferring fourth data from the processing device to the mobile device through the second transmission path, the method further comprising storing the fourth data in the memory of the mobile device.

4. The method according to claim 1, further comprising the display of the content of the memory of the mobile device on a screen of the mobile device.

5. The method according to claim 1, further comprising a delivery of an information signal to a human machine interface of the mobile device, the information signal being representative of the data transfer progress of at least one data transfer of the first and second data transfers.

6. The method according to claim 1, wherein the first data comprises measurement data generated by the sensor and the second data comprises resulting data.

7. The method according to claim 1, further comprising:
encrypting resulting data generated by the processing means of the mobile device from measurement data delivered by the sensor, the resulting data being encrypted by processing device encrypting means of the mobile device before the second data transfer, the second data comprising the encrypted resulting data by processing device encrypting means, and
decrypting the second data by decrypting means of the processing device to obtain the resulting data, the second data being received by the processing device during the second data transfer.

8. The method according to claim 7, further comprising encrypting measurement data by encrypting means of the sensor before the first data transfer, the measurement data being generated by the sensor, the first data comprising the encrypted measurement data.

9. The method according to claim 8, further comprising decrypting the first data by sensor decrypting means of the mobile device to obtain the measurement data, the first data being received by the mobile device during the first data transfer.

10. The method according to claim 6, further comprising:
data processing of resulting data by the processing device; and
generating reporting data;
wherein the second data transfer further comprises transferring the reporting data from the processing device to the mobile device and storing the reporting data in the memory of the mobile device.

11. The method according to claim 3, further comprising the display of the content of the memory of the mobile device on a screen of the mobile device.

12. The method according to claim 11, further comprising a delivery of an information signal to a human machine interface of the mobile device, the information signal being representative of the data transfer progress of at least one data transfer of the first and second data transfers.

13. The method according to claim 12, wherein the first data comprises measurement data generated by the sensor and the second data comprises resulting data.

14. The method according to claim 12, further comprising:
encrypting resulting data generated by the processing means of the mobile device from measurement data delivered by the sensor, the resulting data being encrypted by processing device encrypting means of the mobile device before the second data transfer, the second data comprising the encrypted resulting data by processing device encrypting means, and
decrypting the second data by decrypting means of the processing device to obtain the resulting data, the second data being received by the processing device during the second data transfer.

15. The method according to claim 14, further comprising encrypting measurement data by encrypting means of the sensor before the first data transfer, the measurement data being generated by the sensor, the first data comprising the encrypted measurement data.

16. The method according to claim 15, further comprising decrypting the first data by sensor decrypting means of the mobile device to obtain the measurement data, the first data being received by the mobile device during the first data transfer.

17. The method according to claim 16, further comprising:
data processing of resulting data by the processing device; and
generating reporting data;
wherein the second data transfer further comprises transferring the reporting data from the processing device to the mobile device and storing the reporting data in the memory of the mobile device.

18. A mobile device for transferring data between a condition monitoring device comprising at least one sensor and at least one processing device, the mobile device comprising:
a first communication means configured to communicate with the condition monitoring device to arrange a first transmission path between the sensor and the mobile device to transfer data between the condition monitoring device and the mobile device,
a second communication means configured to communicate with the processing device to arrange a second transmission path between the processing device and the mobile device to transfer data between the processing device and the mobile device, and
a memory configured to store data transfer through the first and second transmission path.
